(19) United States
(12) Patent Application Publication
(10) Pub. No.: US 2012/0142514 A1
(43) Pub. Date: Jun. 7, 2012

(54) SYRINGE FOR SPECIFIC GRAVITY DISTINCTION AND FAT TISSUE COMPONENTS SEPARATING METHOD THEREWITH

(75) Inventor: Hee Young LEE, Seoul (KR)

(73) Assignee: MEDIKAN CO., LTD., Seoul (KR)

(21) Appl. No.: 13/308,739

(22) Filed: Dec. 1, 2011

Related U.S. Application Data
(60) Provisional application No. 61/418,983, filed on Dec. 2, 2010.

(51) Int. Cl. B01L 3/00; B01D 21/26

(52) U.S. Cl. 494/37; 422/548

(57) ABSTRACT

A syringe for fat tissue components distinction including a specific gravity distinction member, and a fat tissue components separating method using the syringe. The syringe for distinguishing crude fat tissue components extracted from the human body into several fat tissue layers by specific gravity includes: a syringe main body in a cylindrical shape for storing the crude fat tissue components extracted from the human body, the syringe main body having a fat intake hole at a front end and an opening at a rear end; and a specific gravity distinction member disposed in the syringe main body and having a specific gravity smaller than about 1.0, wherein the specific gravity distinction member is movable into one of the fat tissue layers that has the same specific gravity as that of the specific gravity distinction member, thereby enabling fat tissue components distinction by specific gravity.

### CROSS-REFERENCE TO RELATED PATENT APPLICATION

This application claims the benefit of U.S. PA No. 61/418,983, filed on Dec. 2, 2010, in the United States Patent and Trademark Office, the disclosure of which is incorporated herein in its entirety by reference.

### BACKGROUND OF THE INVENTION

1. Field of the Invention

The present disclosure relates to a syringe for specific gravity distinction and a fat tissue components separating method therewith, and more particularly, to a syringe for fat tissue components distinction by specific gravity and a fat tissue components separating method using the syringe.

2. Description of the Related Art

In general, fat grafting is one of the ways for replacing soft body skin tissues, and in particular, for cosmetic surgery for, for example, facial wrinkle removal or depression treatment. However, volume loss in the grafted fat is inevitable due to absorption inside the body over time.

Fat grafting necessitates re-surgery because in a severe case about 80-90% of the total transplant fails to survive and is likely to be absorbed by necrosis. These dead tissues may serve as the source of infection, or may further decompose into toxic substances, which may form into severe scar tissues or disrupt even near normal tissues.

The fat aspirate separated from the human body in auto fat grafting includes red blood cells and, free oil isolated from disrupted fat cells, which need to be removed prior to transplantation because the red blood cells are prone to decompose when separated from the body's blood vessels, thereby generating thromboxane A, which serves as ionized free radicals disrupting normal fat tissues, and thus, severely decreasing the survival rate of the grafted fat tissue.

Upon isolation from the fat tissue that serves like a fat reservoir, free oil starts to decompose and ionize to generate free fat acids, which serve as free radicals disrupting normal tissues and normal fat cells, thus leading to a reduced survival rate of the fat tissue and increased damaged cells due to necrosis, which are likely to constitute the breeding medium of secondary inflammatory and unnecessary viral proliferation. Free oil may remain in the walls of fat cells and within cells, thereby serving as a coating layer that may be the major cause of necrosis of the grafted fat cell because the free oil may impede the supply of oxygen necessary for survival of the grafted fat cell.

For these reasons, there are known technologies of removing free oil from extracted body fat tissues. Korean Application No. 2005-0122102 discloses a technology of removing free oil from fat tissues by using a piston (a) illustrated in FIGS. 1 to 3, the piston including a piston main body 10 without a shaft, a packing 20 that is bound to an outer surface of the piston main body 10 to fit tight to an inner wall of a cylindrical cartridge, a free oil discharge hole 30 interconnected between front and rear sides of the piston main body 10, an opening/closing member 40 for opening or closing the free oil discharge hole 30, a filter 50 disposed across a free oil discharge path, and a weight 60 coupled to the rear side of the piston main body 10. This technology using the piston may facilitate isolation of free oil from fat tissues, and further, fat grafting.

Human body fat tissues consist of various components having different specific gravities, which may be separated into multiple fat tissue layers during centrifugation. These fat tissue layers separated by centrifugation may include a relatively high specific gravity layer containing more of a collagen component than fat tissue components, an intermediate specific gravity layer containing the collagen component and fat tissue components in a similar ratio, a relatively low specific gravity layer containing less the collagen component than the fat tissue components, and the lightest layer consisting of free oil.

The above-described existing syringe structure is only suitable for isolating free oil from fat tissues, but not for distinction of fat tissue layers by specific gravity to isolate a particular layer having a desired specific gravity. In particular, those individual fat tissue layers isolated by centrifugation by specific gravity are not visibly distinct to the naked eye, and thus, there have been difficulties in isolating a fat tissue layer having a desired specific gravity.

### SUMMARY OF THE INVENTION

The present disclosure provides a syringe for specific gravity distinction that easily distinguishes crude fat tissue components extracted from the human body into fat tissue layers by specific gravity, thereby enabling easy isolation of a fat tissue layer having a desired specific gravity, and a fat tissue components separating method using the syringe.

According to an aspect of the present invention, there is provided a syringe for distinguishing crude fat tissue components extracted from the human body into several fat tissue layers by specific gravity, the syringe including: a syringe main body in a cylindrical shape for storing the crude fat tissue components extracted from the human body, the syringe main body having a fat intake hole at a front end and an opening at a rear end; and a specific gravity distinction member disposed in the syringe main body and having a specific gravity smaller than about 1.0, wherein the specific gravity distinction member is movable into one of the fat tissue layers that has the same specific gravity as that of the specific gravity distinction member, thereby enabling fat tissue components distinction by specific gravity.

The specific gravity distinction member may have an annular shape, a tubular shape, a meshed sheet form, or a ball-like shape.

When the specific gravity distinction member has an opening, a plug for closing the opening may be detachably inserted into the opening.

The specific gravity distinction member may be a meshed sheet having a pore size from about 300 μm to about 2000 μm.

The specific gravity distinction member may be formed using non-foam plastic, foam plastic, a ball, metal, or a combination of at least two thereof.

The specific gravity distinction member may have varying specific gravities.

The specific gravity distinction member may be a combination of separate members having different specific gravities.

The specific gravity distinction member may include a plurality of specific gravity distinction members having different specific gravities disposed between the opening and the fat intake hole.

The syringe may further include a first piston that includes: a first main body that is disposed to be slidable forward and backward along an inner wall of the syringe main body; a first packing that is bound to an outer surface of the first main body to tightly fit to the inner wall of the syringe main body; a first discharge unit that interconnects front and rear sides of the first main body to discharge through only fat tissue components having a smaller size than a predetermined size; and a first filtering member disposed across the first discharge unit to only selectively pass through the fat tissue components smaller than the predetermined size.

The first piston may be disposed either or both between the specific gravity distinction member and the fat intake hole, or/and the specific gravity distinction member and the opening.

The first piston may include a first weight for increasing a total weight of the first piston.

The specific gravity distinction member may be a second piston that includes: a second main body that is disposed to be slidable forward and backward along the inner wall of the syringe main body; a second discharge unit that interconnects front and rear sides of the second main body; and a second filtering member disposed across the second discharge unit to filter off fat tissue components larger than a predetermined size.

According to another aspect of the present invention, there is provided a fat tissue components separating method using one of the syringes described above that excludes the first piston, the method including: extracting the crude fat tissue components from the human body into the syringe main body through the fat intake hole; centrifuging the syringe main body containing the crude fat tissue components to distinguish the crude fat tissue components into multiple fat tissue layers by specific gravity and at the same to move the specific gravity distinction member in one of the fat tissue layers having the same specific gravity as the specific gravity distinction member; and recovering the fat tissue layer identified by the specific gravity distinction member through the fat intake hole or the opening.

A fat tissue components separating method using one of the syringes described above that includes the first piston includes: extracting the crude fat tissue components from the human body into the syringe main body through the fat intake hole; centrifuging the syringe main body containing the crude fat tissue components to force free oil to move to a rear side of the first piston, and the specific gravity distinction member to move in one of the fat tissue layers having the same specific gravity as the specific gravity distinction member between the first piston and the gat intake hole; and selectively recovering a fat tissue layer having a particular specific gravity from the syringe main body.

### BRIEF DESCRIPTION OF THE DRAWINGS

The above and other features and advantages of the present disclosure will become more apparent by describing in detail exemplary embodiments thereof with reference to the attached drawings in which:

FIGS. 1 to 3 are views of an existing syringe for free oil separation;

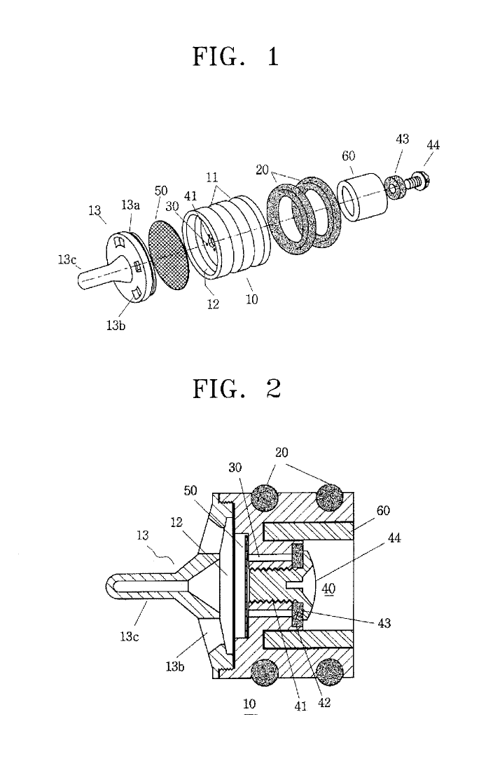

FIG. 4 is a cross-sectional view of a syringe according to an embodiment of the present disclosure;

FIG. 5 is an operational view of the syringe of FIG. 4; and

FIGS. 6 to 9 are views of specific gravity distinction members of syringes according to embodiments of the present disclosure.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

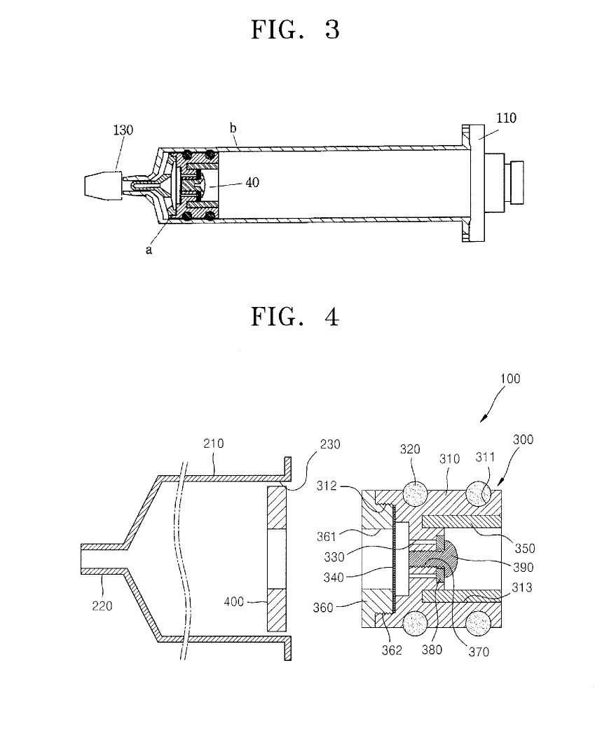

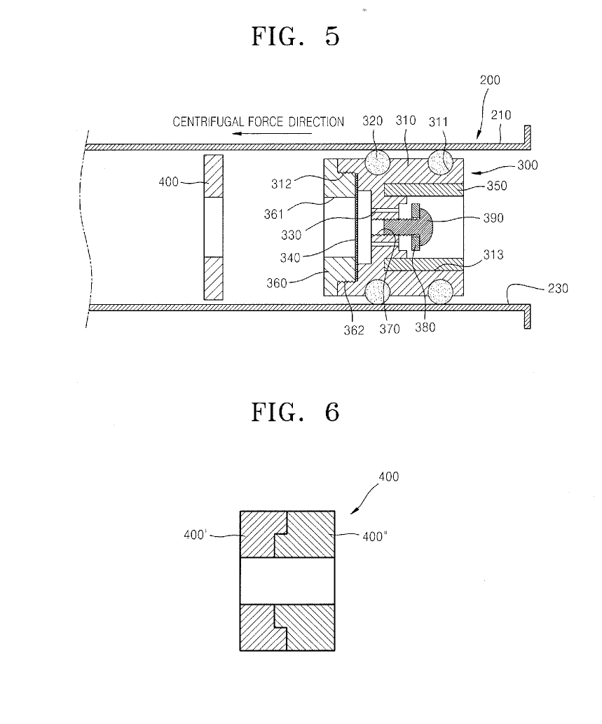

FIG. 4 is a cross-sectional view of a syringe 10 for fat tissue components distinction according to an embodiment of the present disclosure and FIG. 5 is an operational view of the syringe of FIG. 4. Referring to FIG. 4 and FIG. 5, the syringe 100 for distinguishing crude fat tissue components extracted from the human body by specific gravity into several fat tissue layers having different specific gravities includes a syringe main body 200 and a specific gravity distinction member 400.

The syringe main body 200 may have a cylindrical shape with a fat intake hole 220 at a front end and an opening 230 at a rear end. The syringe main body 200 may serve as a container of the fat tissue components extracted from the human body, and may include the specific gravity distinction member 400 therein.

In particular, the syringe main body 200 may include a cylindrical body 210, the fat intake hole 220 having a smaller diameter than that of the body 210 at the front end and to which a needle unit (not shown) may be coupled, and the opening 230 at the rear end of the body 210 with a flange.

The specific gravity distinction member 400, which may be disposed in the syringe main body 200, may have a low specific gravity relative to water. The specific gravity distinction member 400 may be movable into one of the fat tissue layers that has the same specific gravity as its own specific gravity after centrifugation by which crude fat tissue components are separated into the fat tissues layers having different specific gravities, thereby enabling fat tissue components distinction by specific gravity.

In some embodiments the specific gravity distinction member 400 may have a specific gravity smaller than 1.0. The specific gravity distinction member 400 may have an annular shape, as illustrated in FIG. 4, but is not limited thereto. In some embodiments the specific gravity distinction member 400 may have a tubular shape, a meshed sheet form, or a ball-like shape.

The specific gravity distinction member 400 may be a meshed sheet having a pore size of about 300 μm to about 2000 μm. When the specific gravity distinction member 400 is such a meshed sheet, the specific gravity distinction member 400 may distinguish fat tissue components by size and specific gravity at the same time.

The specific gravity distinction member 400 may be formed using non-foam plastic, foam plastic, a ball, metal, or a combination of at least two thereof. The syringe 100 for fat tissue components distinction described above may be used as follows.

<Fat Extraction Step>

Crude fat tissue components extracted from the human body into the syringe main body 200 through the fat intake hole 220.

<Fat Distinction Step>

The syringe main body 210 with the fat tissue components contained therein is centrifuged to distinguish the fat tissue components into multiple fat tissue layers and at the same time move the specific gravity distinction member 400 in one of the fat tissue layers having the same specific gravity as the specific gravity distinction member 400.

<Fat Recovery Step>

The fat tissue layer of which the specific gravity is identified by the specific gravity distinction member 400 from the other fat tissue layers is recovered through the fat intake hole 220 or the opening 230. Only one specific gravity distinction member 400 or a plurality of specific gravity distinction members 400 having different specific gravities may be used. Use of the plurality of specific gravity distinction members 400 having different specific gravities may ensure convenient distinction and separation of multiple fat tissue layers having desired, different specific gravities.

Using the syringe for specific gravity distinction described above, a fat tissue components having a desired specific gravity may be easily identified and separated by the specific gravity distinction member 400.

In one embodiment, the syringe for specific gravity distinction may further include a first piston 300 for separating free oil.

The first piston 300 may be disposed between the opening 230 and the specific gravity distinction member 400 so that only free oil of the crude fat tissue components extracted from the human body may pass through the first piston 300. That is, the free oil is discharged through the rear end of the first piston 300, while the rest of the fat tissue components remains on the front side of the first piston 300.

The first piston 300 may include a first main body 310, a first packing 320, a first discharge unit 330, a first filtering member 340, and a first weight 350.

The first main body 310 may have a cylindrical shape with a first groove 311 in an outer circumference within which the first packing 320 is receivable. The first main body 310 may have the first discharge unit 330 in the middle to interconnect front and rear sides of the first main body 310.

The first main body 310 may have a first internal screw thread 312 on the front side to fix a first filtering member 340 to the first main body 310. The first filtering member 340 may be fixed to the first main body 310 by a first cap member 360 screw-coupled to the first internal screw thread 312. The first main body 310 may have a first receiving unit 313 on the rear side into which the first weight 350 may be inserted. The first receiving unit 313 may have an inner diameter larger than a diameter of the first discharge unit 330 and may be interconnected to the first discharge unit 330.

The first packing 320, which may be bound to the outer surface of the first main body 310, may tightly seal a gap between an internal wall of the main body 200 and the first main body 310. The first packing 320 may be made from any common packing material, for example, a rubber material.

The first packing 320 may include a pair of packings bound to the outer surface of the first main body 310 and separated from each other in the front and rear directions of the first piston 300, but is not limited thereto. For example, the first packing 320 may include only a single packing.

The first discharge unit 330 interconnected between the front and rear sides of the first main body 310 may form a first discharge path for exclusively discharging free oil. The first discharge unit 330 may be in the first main body 310. The first discharge unit 330 may guide the free oil passing through the first filtering member 340 to flow to the rear end of the first main body 310.

The first filtering member 340 may be disposed on the first discharge path to pass only the free oil of the fat tissue components. The first filtering member 340 may be any of a variety of free-oil selective filtering devices, although the first filtering member 340 is implemented as a meshed filter having a predetermined pore size in the present embodiment.

The first weight 350 may be a metallic ring, which may be detachably connected to the rear side of the first main body 310. The first weight 350, which is for increasing a total weight of the first piston 300, may be disposed on the first receiving unit 313 of the first main body 310. When coupled to the first piston 310, the first weight 350 may enhance the centrifugal force exerted on the first piston 300 during centrifugation.

Reference numerals 360, 370, 380, and 390 denote the first cap member, a screw groove, a sealing member, and an opening/closing screw.

The first cap member 360 may be detachably coupled to the front side of the first main body 310 with a first through hole 361 in the middle and a first cap screw thread 362 in a side region that may be screw-coupled with the first internal screw thread 312 of the first filtering member 340. The first cap member 360 may attach the first filtering member 340 to be fixed to the first main body 310.

The screw groove 370 may be formed in the first main body 310 so as to be screw-coupled with the opening/closing screw 390. The sealing member 380 may enable the opening/closing screw 390 to open or close the first discharge unit 330. The sealing member 380 may open or close the first discharge unit 330 by being in contact with a facing opening of the first discharge unit 330.

The opening/closing screw 390 is screw-coupled to the screw groove 370, pushing the sealing member 380 closer to contact with the first discharge unit 330, thereby ensuring a leak-free coupling. When the opening/closing screw 390 is removed to open the first discharge unit 330 by releasing the leak-free coupling, free oil may be allowed to flow out through the first discharge unit 330.

Fat tissue components distinction processes with the first piston 300 disposed at the rear of the specific gravity distinction member 400 are as follows.

<Fat Extraction Step>

Crude fat tissue components are extracted from the human body into the syringe main body 200 through the fat intake hole 220. To this end, with the specific gravity distinction member 400 and the first piston 300 inserted in advance into the syringe main body 200, the opening/closing screw 390 in the first piston 300 is screw-coupled to the screw groove 370, pushing the sealing member 380 to close the first discharge unit 330. Then, the first piston 300 is pulled toward the opening 230, thereby sucking fat tissue components out of the human body.

<Fat Distinction Step>

Once the crude fat tissue components are sucked into the syringe main body 200, the fat intake hole 220 of the syringe main body 200 is clogged with a predetermined stopper (not shown), and the opening/closing screw 390 is loosened to have the sealing member 380 open the first discharge unit 330. In this state, the syringe main body 200 is put into a centrifuge and subjected to centrifugation. During the centrifugation the first piston 300 moves in the centrifugal force direction, as illustrated in FIG. 5, so that free oil is squeezed out through the first discharge unit 330 toward the rear side of the first piston 300. As a result, the rest of the fat tissue components from which the free oil has been squeezed out may remain on the front side of the first piston 300. The specific gravity distinction member 400 may be moved in a fat tissue layer having the same specific gravity as that of specific gravity distinction member 400 between the first piston 300 and the fat intake hole 220.

Loading the first weight 350 into the first piston 300 may cause the first piston 300 to further move toward the fat intake hole 220 during the centrifugation to press the fat tissue components so that the free foil is squeezed out more from the fat tissue components.

<Fat Recovery Step>

Once the crude fat tissue components are separated into the fat tissue components and the free oil according to intention, the predetermined stopper is removed from the fat intake hole 220, and a needle is inserted in the open fat intake hole 220 to recover the fat tissue layer having a desired specific gravity. For example, after the insertion of the needle in the fat intake hole 220, the fat tissue layer having the desired specific gravity is separated by visually referring to the specific gravity distinction member 400 in the fat tissue layers.

Next, while kept on the rear side of the first piston 300 by coupling the opening/closing screw 390 of the first piston 300 to the screw groove 370 to block the free oil from moving back forward through the first discharge unit 330, the free oil is discharged through the opening 230.

In an embodiment, the first piston 300 may be disposed between the fat intake hole 220 and the specific gravity distinction member 400. In this regard, the sealing member 380 and the opening/closing screw 390 may be detached from the first piston 300 depending on the type of the specific gravity distinction member 400. Placing the first piston 300 forward the specific gravity distinction member 400 enables pre-filtering by the first piston 300 of inappropriate fat tissue components which are too large to be reinjected into the human body.

In an embodiment of the present disclosure, the first piston 300 may be disposed both between the fat intake hole 220 and the specific gravity distinction member 400, and between the specific gravity distinction member 400 and the opening 230 at the same time.

The syringes for fat tissue components distinction described in the above embodiments of the present disclosure may be modified as follows.

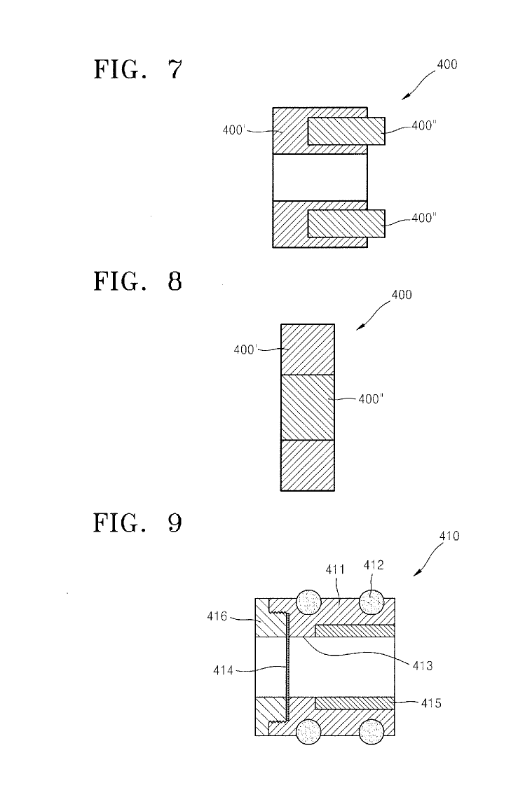

Although the specific gravity distinction member 400 is described above as being a single member or a combination of multiple members, the present disclosure is not limited thereto. For example, the specific gravity distinction member 400 may have varying specific gravities. For example, the specific gravity distinction member 400 may be a combination of separate structures 400′ and 400″ having different specific gravities that are detachable from one another, as illustrated in FIGS. 6 and 7. Advantageously, these configurations of the specific gravity distinction member 400 enable specific gravity adjustment on the specific gravity distinction member 400 to a desired level.

In another embodiment, a plug 400″ may be detachably inserted into an opening of the specific gravity distinction member 400′, as illustrated in FIG. 8. When coupled with the plug 400″, the specific gravity distinction member 400′ may also serve as a piston, optionally with a packing (not shown) attached to outer surface of the specific gravity distinction member 400′.

Although the above embodiments suggest that only one specific gravity distinction member 400 be disposed in front of the first piston 300, a plurality of specific gravity distinction members 400 having different specific gravities may be disposed in front of the first piston 300, which may ensure simultaneous separations of fat tissue components in a desired range of specific gravities.

The specific gravity distinction member may be provided with a filtering member (not shown), like the first piston 300. For example, as illustrated in FIG. 9, the specific gravity distinction member may be implemented as a second piston 410, which may include a second main body 411 that is disposed to be slidable forward and backward along an inner wall of the syringe main body 200, a second discharge unit 413 that interconnects the front and rear sides of the second main body 411 to discharge through only fat tissue components smaller than a predetermined size, and a second filtering member 414 across the second discharge unit 413 to only selectively pass free oil of the fat tissue components.

The second filtering member 414 may be supported by a second cap member 416 that may be screw-coupled to the second main body 411. The specific gravity distinction member 400 may distinguish fat tissue components both by specific gravity and by size. The specific gravity distinction member 400″ may have varying specific gravities.

The second filtering member 414 may be a meshed filter, but is not limited thereto; the second filtering member 411 may be in any of a variety of forms.

According to the one or more embodiments of the present disclosure described above, the syringe for fat tissue components distinction includes a specific gravity distinction member having a predetermined specific gravity in a syringe main body, which may ensure fat tissue components separated by centrifugation to be readily distinct, so that the fat tissue components may be easily recovered by specific gravity.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A syringe for distinguishing crude fat tissue components extracted from the human body into several fat tissue layers by specific gravity, the syringe comprising:
a syringe main body in a cylindrical shape for storing the crude fat tissue components extracted from the human body, the syringe main body having a fat intake hole at a front end and an opening at a rear end; and
a specific gravity distinction member disposed in the syringe main body and having a specific gravity smaller than about 1.0,
wherein the specific gravity distinction member is movable into one of the fat tissue layers that has the same specific gravity as that of the specific gravity distinction member, thereby enabling fat tissue components distinction by specific gravity.

2. The syringe of claim 1, wherein the specific gravity distinction member has an annular shape, a tubular shape, a meshed sheet form, or a ball-like shape.

3. The syringe of claim 2, wherein, when the specific gravity distinction member has an opening, a plug for closing the opening is detachably inserted into the opening.

4. The syringe of claim 2, wherein the specific gravity distinction member is a meshed sheet having a pore size from about 300 μm to about 2000 μm.

5. The syringe of claim 1, wherein the specific gravity distinction member is formed using non-foam plastic, foam plastic, a ball, metal, or a combination of at least two thereof.

6. The syringe of claim 5, wherein the specific gravity distinction member has varying specific gravities.

7. The syringe of claim 6, wherein the specific gravity distinction member is a combination of separate members having different specific gravities.

8. The syringe of claim 1, wherein the specific gravity distinction member comprises a plurality of specific gravity distinction members having different specific gravities disposed between the opening and the fat intake hole.

9. The syringe of claim 1, further comprising a first piston that comprises:
a first main body that is disposed to be slidable forward and backward along an inner wall of the syringe main body;
a first packing that is bound to an outer surface of the first main body to tightly fit to the inner wall of the syringe main body;
a first discharge unit that interconnects front and rear sides of the first main body to discharge through only fat tissue components having a smaller size than a predetermined size; and
a first filtering member disposed across the first discharge unit to only selectively pass through the fat tissue components smaller than the predetermined size.

10. The syringe of claim 9, wherein the first piston is disposed either or both between the specific gravity distinction member and the fat intake hole, or/and the specific gravity distinction member and the opening.

11. The syringe of claim 9, wherein the first piston comprises a first weight for increasing a total weight of the first piston.

12. The syringe of claim 1, wherein the specific gravity distinction member is a second piston that comprises: a second main body that is disposed to be slidable forward and backward along the inner wall of the syringe main body; a second discharge unit that interconnects front and rear sides of the second main body; and a second filtering member disposed across the second discharge unit to filter off fat tissue components larger than a predetermined size.

13. A fat tissue components separating method using the syringe of claim 1, the method comprising:
extracting the crude fat tissue components from the human body into the syringe main body through the fat intake hole;
centrifuging the syringe main body containing the crude fat tissue components to distinguish the crude fat tissue components into multiple fat tissue layers by specific gravity and at the same to move the specific gravity distinction member in one of the fat tissue layers having the same specific gravity as the specific gravity distinction member; and
recovering the fat tissue layer identified by the specific gravity distinction member through the fat intake hole or the opening.

14. A fat tissue components separating method using the syringe of claim 9, the method comprising:
extracting the crude fat tissue components from the human body into the syringe main body through the fat intake hole;
centrifuging the syringe main body containing the crude fat tissue components to force free oil to move to a rear side of the first piston, and the specific gravity distinction member to move in one of the fat tissue layers having the same specific gravity as the specific gravity distinction member between the first piston and the gat intake hole; and
selectively recovering a fat tissue layer having a particular specific gravity from the syringe main body.
